(19) United States
(12) Patent Application Publication
(10) Pub. No.: US 2025/0075978 A1
(43) Pub. Date: Mar. 6, 2025

(54) GAS FURNACE WITH HEAT SHIELDING PLATE

(71) Applicant: Daikin Comfort Technologies Manufacturing, L.P., Waller, TX (US)

(72) Inventors: Randy Rodrigo Soldevilla, Cypress, TX (US); Sien Fong Goh, Cypress, TX (US); Jianmin Zhang, Katy, TX (US)

(73) Assignee: Daikin Comfort Technologies Manufacturing, L.P., Waller, TX (US)

(21) Appl. No.: 18/457,881

(22) Filed: Aug. 29, 2023

(51) Int. Cl. F27D 1/00

(52) U.S. Cl. CPC F27D 1/0033

(57) ABSTRACT

A furnace assembly is disclosed that includes an intake manifold connectable to a fuel supply, a partition panel, and a burner assembly mountable to the partition panel and operable to combust a pre-mixed fuel and air mixture to produce a heated flue gas. The burner assembly includes burners configured to combust of the mixture into a flue gas. The burner assembly also includes a heat shielding plate located and shaped to reduce heat communicated to the partition panel due to the combustion. The heat shielding plate is manufactured using a high-temperature alloy and includes holes, each hole aligned with one of the burners. A groove in the plate accommodates thermal expansion of and reduces thermal deformation of the plate. A heat exchanger is mounted to the partition panel in thermal communication with the burners that includes tubes positioned to receive the heated flue gas.

### BACKGROUND

This section is intended to introduce the reader to various aspects of the art that may be related to various aspects of the presently described embodiments—to help facilitate a better understanding of various aspects of the present embodiments. Accordingly, it should be understood that these statements are to be read in this light, and not as admissions of prior art.

A residential furnace includes a heat exchanger (“HX”) that has a bank of heat exchange tubes arranged such that air circulated by a blower passes between the tubes to be heated before the heated air passes to a distribution duct of a heating system. Each of the tubes has an inlet that receives heat from a burner where a combustible fuel such as natural gas is mixed with air and combusted to form a heated flue gas. Each of the tubes also includes an outlet end which is fluidly connected to an inducer blower for drawing the heated flue gas therethrough, and a plurality of passes through which the heated flue gas passes. As the flue gas is routed through the HX, the HX extracts the heat therefrom. The flue gas thus heats the surface of the HX and an air stream is blown across the exterior of the HX using the blower, transferring heat from the HX to the air stream by convection. The heated air stream is circulated within a structure to add heat to the inside of the structure.

One type of burner that may be used in a furnace is a pre-mix burner. In such a burner, fuel and air are mixed before being injected into a combustion zone where an ignition source ignites the mixture. Pre-mix burners exhibit short reaction zones and high burning rates. This leads to short residence time and high combustion efficiency, which limits production and emission of undesirable byproducts of combustion, such as NOx. “Residence time” refers to a probability distribution function that describes the amount of time a fluid element could spend inside a chemical reactor such as, for example, a combustion chamber. Pre-mix burners may therefore be preferred in heating systems, particularly in countries with strict NOx emission regulations.

However, high temperatures of pre-mix burners can be detrimental to the burner itself. For example, some burner gaskets made of ceramic fiber-based sheet materials may degrade under high combustion heat and repeated ignitions when the fuel/air mixture experiences sudden expansion during combustion. Remnants of degraded gasket materials may enter the HX tubes and the inducer blower, causing reduced heat transfer effectiveness, insufficient combustion flue gas drafting, and combustion noises.

### SUMMARY

Certain aspects of some embodiments disclosed herein are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

Embodiments of the present disclosure generally relate to a furnace assembly for use with a combustible fuel from a fuel supply. The furnace assembly includes an intake manifold connectable to the fuel supply, a partition panel, and a burner assembly mountable to the partition panel and operable to combust a pre-mixed fuel and air mixture to produce a heated flue gas. The burner assembly includes a housing connected in fluid communication with the intake manifold. Inside the housing are burners, each burner configured to produce a flame for the combustion of the mixture into a flue gas. The burner assembly also includes a heat shielding plate located and shaped to reduce heat communicated to the partition panel due to the combustion. The heat shielding plate is manufactured using a high-temperature alloy and includes holes through the plate, each hole aligned with one of the burners. A groove in the plate extending between the holes is shaped to accommodate thermal expansion of and reduce thermal deformation of the plate. The furnace assembly also includes a heat exchanger mounted to the partition panel in thermal communication with the burners and that includes tubes positioned to receive the heated flue gas from the burners.

Another embodiment includes a method of operating a furnace assembly for use with a combustible fuel from a fuel supply to heat an interior of a structure. The method includes supplying fuel from a fuel supply to an intake manifold and supplying air to the intake manifold to form a pre-mixed fuel and air mixture. The pre-mixed fuel and air mixture then flows to a burner assembly. The method includes combusting the pre-mixed fuel and air mixture on burners of the burner assembly to produce a heated flue gas. The method also includes reducing an amount of heat from the combustion communicated to a partition panel to which the burner assembly is mounted with a heat shielding plate. The heat shielding plate is manufactured using a high-temperature alloy and includes holes through the plate, each hole aligned with one of the burners. The method also includes compressing a groove in the heat shielding plate between the holes during the combustion to accommodate thermal expansion of and reduce thermal deformation of the plate. Further, the method includes operating a blower downstream of the burner assembly to create a negative pressure in a heat exchanger mounted to the partition panel in thermal communication with the burner and comprising tubes and pull the heated flue gas into the tubes. The method also includes passing an air stream over an exterior of the tubes to transfer heat from the heated flue gas in to tubes to the air stream to produce a heated air stream and flowing the heated air stream into the interior of the structure.

Advantageously, certain disclosed embodiments may provide a heat shielding plate manufactured using a high-temperature alloy that is able to withstand heating cycles associated with operating the furnace assembly by being configured to thermally expand under operating combustion temperatures and return to size when the furnace assembly is not undergoing a combustion cycle.

Various refinements of the features noted above may exist in relation to various aspects of the present embodiments. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. Again, the brief summary presented above is intended only to familiarize the reader with certain aspects and contexts of some embodiments without limitation to the claimed subject matter.

### BRIEF DESCRIPTION OF THE DRAWINGS

These and other features, aspects, and advantages of certain embodiments will become better understood when the following detailed description is read with reference to the accompanying drawings in which like characters represent like parts throughout the drawings.

FIG. 1 is a schematic view of a structure with a furnace, in accordance with one or more embodiments.

FIG. 2A is a schematic perspective view of a furnace assembly of FIG. 1, in accordance with one or more embodiments.

FIG. 2B is a schematic side view of the furnace assembly of FIG. 1, in accordance with one or more embodiments.

FIGS. 3A is an exploded perspective view of a burner assembly of FIG. 2A, in accordance with one or more embodiments.

FIG. 3B is a front view of the burner assembly of FIG. 2A, in accordance with one or more embodiments.

FIGS. 4A-4C are perspective, plan, and front views of an example heat shielding plate usable in the burner assembly of FIG. 2A, in accordance with one or more embodiments.

### DETAILED DESCRIPTION

One or more specific embodiments of the present disclosure will be described below. In an effort to provide a concise description of these embodiments, not all features of an actual implementation may be described. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments, the articles “a,” “an,” “the,” and “said” are intended to mean that there are one or more of the elements. The terms “comprising,” “including,” and “having” are intended to be inclusive and mean that there may be additional elements other than the listed elements.

The present disclosure relates to a furnace with a burner assembly mounted to a partition panel that separates the burner assembly from a plenum where a heat exchanger, including heat exchanger tubes, is located. A fuel and air mixture is combusted at burners of the burner assembly to produce a heated flue gas that then travels into the heat exchanger tubes to produce heat for heating the inside of a structure. To protect the partition panel from heat produced by the combustion of the mixture, the burner assembly includes a heat shielding plate located between the burner assembly and the partition panel that is made of a high-temperature alloy. The heat shielding plate absorbs some of the heat from the combustion and reduces heat communicated to the partition panel.

Furnaces operate by cycling between combustion to produce heat and non- combustion when heat is not needed. Therefore, the burner assembly goes through multiple heat stress cycles. The heat shielding plate also experiences cycles of thermal stress that produce thermal expansion. To accommodate the thermal expansion without permanent deformation, the heat shielding plate includes structural features such as a groove across the plate. The groove cross-section profile allows the plate to expand and reduces thermal deformation of the plate. Further, two short sides of the plate include angled flanges that engage the plate within a housing of the burner assembly but that are also shaped to allow thermal expansion of the plate. Further, at least one of the long sides of the plate includes at least one tab sized to prevent the heat shielding plate from fitting completely inside the housing. The tab maintains flatness of the plate while allowing thermal expansion under elevated operational temperatures. The physical features of the plate thus allow the plate material to return to original shape between each and after repeated thermal expansion cycles.

Additionally, the plate includes holes through the plate, each aligned with one of the burners. The holes allow the communication of the combusted flue gas through the plate to the heat exchanger. The holes may each also include a lip with a curved funnel cross-section profile. The curved funnel profile helps direct the flow of flue gas from the burners into the heat exchanger tubes. The curved funnel profile also helps shield the heat from the combustion from being communicated to the partition panel.

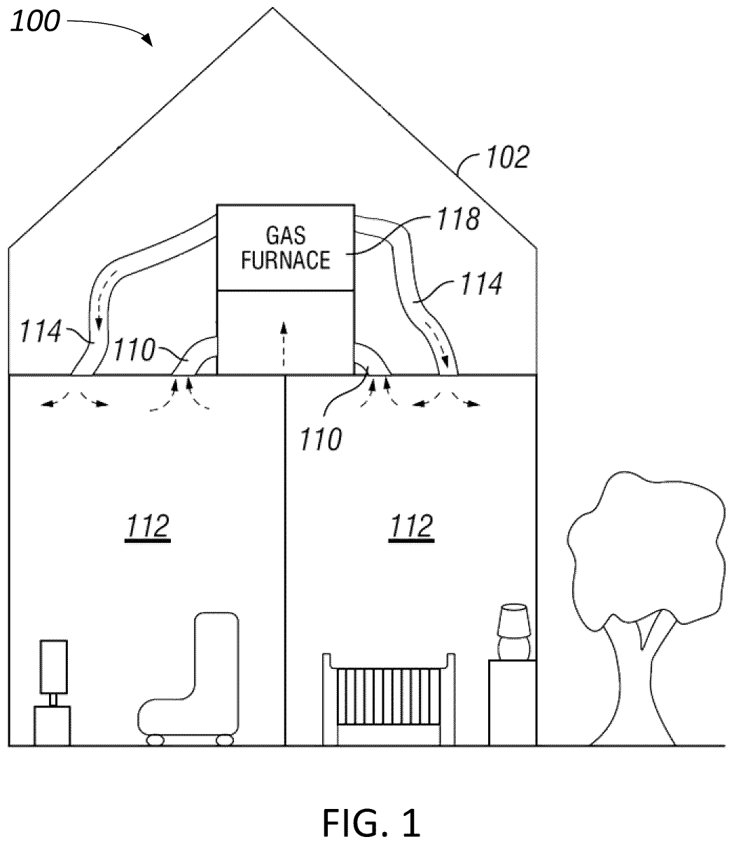

Turning now the figures, FIG. 1 illustrates a schematic of a heating system 100 in accordance with one or more embodiments. As depicted, the heating system 100 may heat a residential structure 102. However, the concepts disclosed herein are applicable to numerous of heating situations, which include industrial and commercial settings.

As shown, the heating system 100 includes a gas furnace 118. The gas furnace 118 combusts fuel, such as natural gas, to produce heat in heat exchanger tubes (discussed below) that serpentine through the gas furnace 118. These tubes may function as a heating element for the ambient indoor air flowing over the tubes and into the ducts 114.

To heat air inside the structure 102, the heating system 100 draws indoor air from one or more climate-controlled spaces 112 via returns 110. The heating system 100 passes the indoor air over a heating source and routes the warmed or heated air back to the climate-controlled spaces 112 through ducts or ductworks 114—which are pipes that may be rigid or flexible.

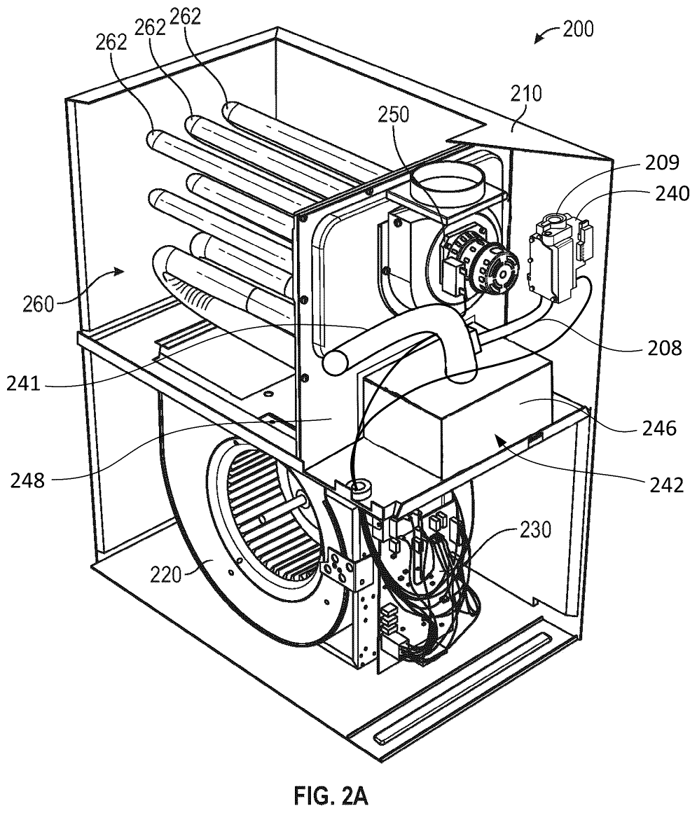

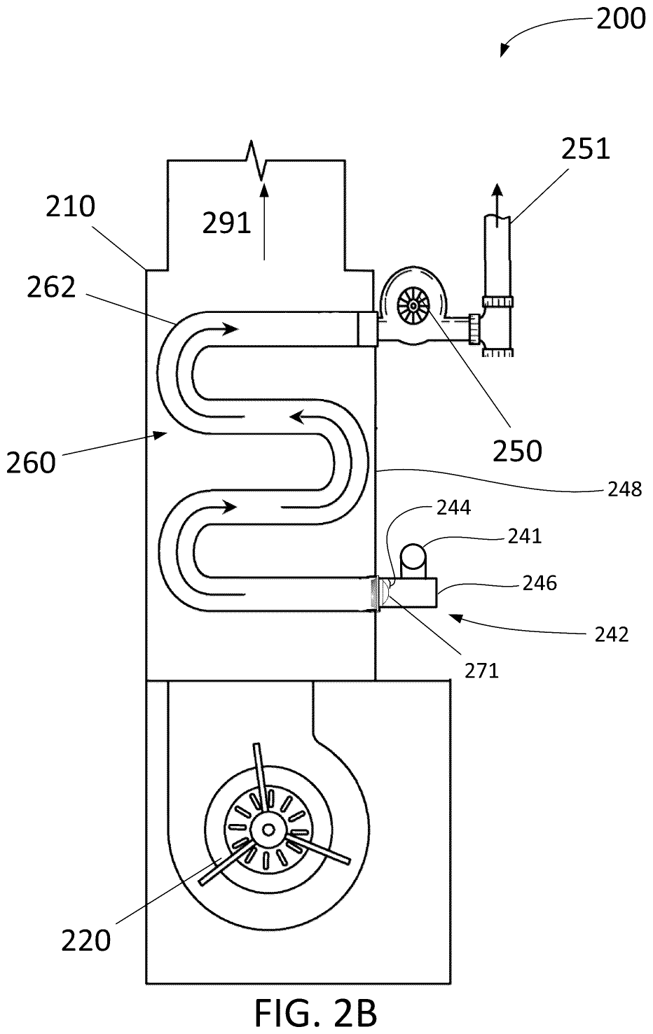

FIGS. 2A and 2B illustrate a perspective schematic view and a side schematic view respectively of a furnace assembly 200 that may correspond to the furnace 118 shown in FIG. 1. The furnace assembly 200 is described without limitation in terms of a gas-fired system. Those skilled in the pertinent art will appreciate that the principles disclosed herein may be extended to furnace systems using different fuel types, for example, natural gas, propane, or hydrogen. The furnace assembly 200 includes a cabinet 210 that may be manufactured from, for example, heavy-gauge steel. The cabinet 210 may be coated with a durable finish, such as baked-enamel, to resist corrosion and protect components inside the cabinet 210. In some locations, the cabinet 210 may also be thermally insulated to reduce heat loss, maximize heat transfer efficiency, and lower operation noise. The cabinet 210 encloses a blower 220, which may be a variable-speed blower for ramping up and down flow of an air stream across a heat exchanger (HX) assembly 260, according to an operation demand of the furnace assembly 200. The cabinet 210 also encloses a controller 230 that may include self-diagnostic capabilities and may also continuously monitor and control the operation of the furnace assembly 200.

The furnace assembly 200 includes an air intake (not shown) that is fluidly coupled to an air supply line (not shown). The air supply line is fluidly coupled to an intake manifold 241. A fuel valve 240 regulates a volume of a fuel supplied to a fuel tube 208 from a combustible fuel supply (not shown) through an inlet 209 of the fuel valve 240. The fuel valve 240 may be, for example, an electrically-actuated solenoid valve that opens or closes responsive to an electrical signal. As another example, the fuel valve 240 may be a two-stage valve. The fuel tube 208 supplies the fuel from the fuel valve 240 to the intake manifold 241 where the fuel mixes with air supplied through the intake manifold 241 and the air supply line to form a fuel/air mixture.

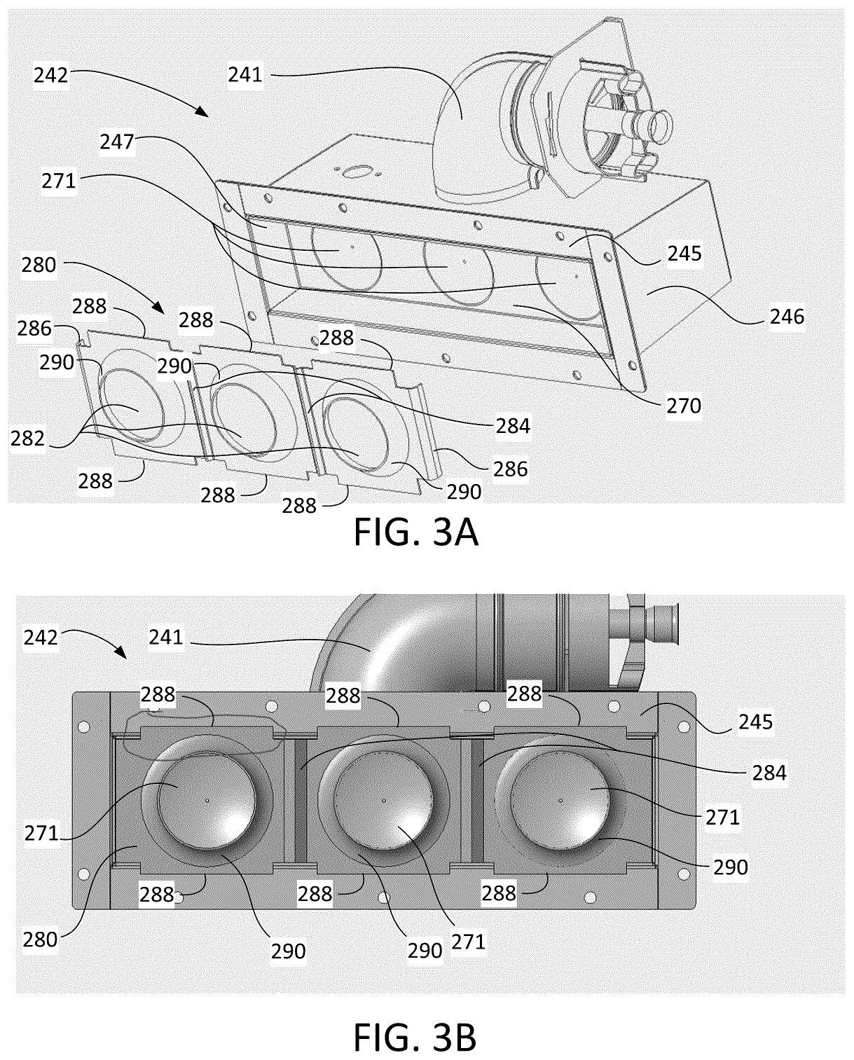

The furnace assembly 200 also includes a burner assembly 242 for igniting and combusting the fuel/air mixture. As shown in more detail in FIGS. 3A and 3B, the burner assembly 242 includes a burner box or housing 246 mounted to a partition panel 248. The burner assembly 242 also includes a pre-mix burner surface 270 with multiple convex portions, or burners 271 that receive the fuel/air mixture inside the housing 246 from the intake manifold 241. The pre-mix burner surface 270 may include any suitable number of burners 271. Although shown in either a three burner or two burner configuration, the burner assembly 242 may also, for example, include four, five, or six burners 271. The burners 271 may have a convex shape with respect to the direction of the flow of the fuel/air mixture such that the burners 271 curve toward the intake manifold 241. The burners 271 are shaped such that combustion of the fully mixed fuel/air mixture occurs to create a combustion flame and produce a heated flue gas that passes through an opening in the partition panel 248. The metal fiber mesh is shaped to anchor the flame at the burners 271 and prevent the flame from being blown out. The burners 271 may be fabricated using suitable materials such as a metal fiber mesh. For example, the burners 271 may be fabricated using a woven mesh made of stainless steel, stainless steel alloy, chrome, aluminum iron alloy, ceramic, or other suitable materials for withstanding combustion temperatures of the furnace assembly 200.

The burner assembly 242 also includes one or more igniters 244 for igniting the fuel/air mixture at the burners 271. The igniters 244 may be silicon nitride igniters that do not need a pilot light. When the burners 271 are ignited to produce a flame, the fuel and ambient air being pre-mixed allows the fully mixed mixture to be combusted more efficiently. Fully pre-mixing of the fuel/air mixture also reduces NOx emissions from the combustion of the fully mixed mixture compared to ambient air and fuel that are not fully mixed. Such NOx reduction can be achieved at least due to less ambient air being needed in the fully mixed mixture for combustion. Additionally, combustion of a fully mixed mixture allows for a short flame length to achieve complete combustion. For example, the flame may have a length of four inches but also may be shorter. As another example, the flame may have a length of three inches.

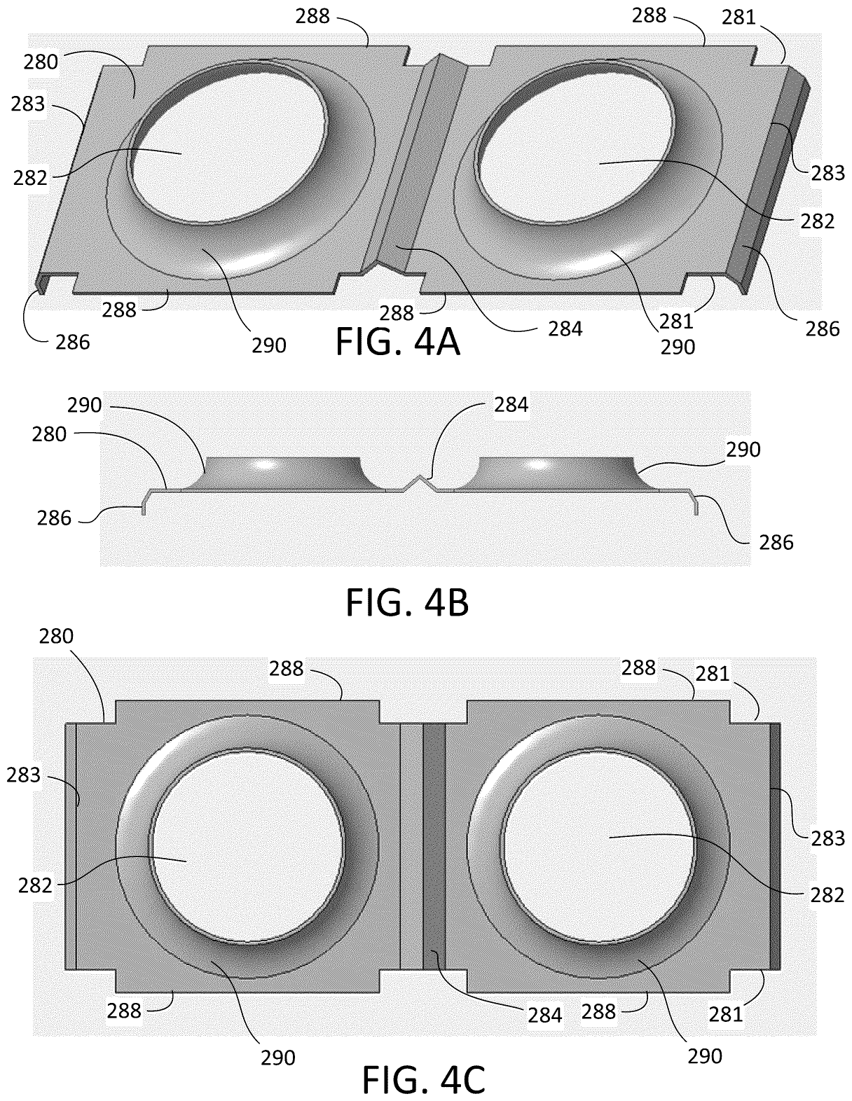

The burner assembly 242 also includes a heat shielding plate (HSP) 280 located between the burner surface 270 and the partition panel 248. The HSP 280 may be fabricated from a high-temperature alloy. A “high-temperature alloy” may broadly refer to materials that provide strength, environmental resistance including oxidation resistance, and structural stability within a temperature range of 500° F. (260° C.) to 2200° F. (1205° C.). While different high-temperature alloys are suitable, an example alloy of the HSP is a ferritic iron-chromium-aluminum (FeCrAl) alloy. The HSP 280 has a generally rectangular profile with two long sides 281 and two short sides 283 as shown in FIGS. 4A and 4C.

As shown in more detail in FIGS. 4A-4C, the HSP 280 includes holes 282 matching the number of, and aligned with, the burners 271. As with the number of burners 271, there may be any number of holes 282. A diameter of the holes 282 generally matches a diameter of the burners 271. For example, the holes may be 1.5 inches (38.1 mm) to 1.75 inches (44.45 mm) in dimeter. In other examples, the holes may be 2.25 inches (57.15 mm) to 2.5 inches (63.5 mm) in diameter. The holes 282 in the HSP 280 allow the combusted and heated flue gas to pass through the HSP 280 and into heat exchanger tubes 262 of the HX assembly 260.

The HSP 280 experiences cycles of thermal stress that produce thermal expansion from repeated ignition and combustion of the fuel/air mixture. To accommodate such thermal expansion without permanent deformation, the HSP 280 may include structural features such as one or more grooves 284. The grooves 284 may extend across HSP 280 between the long sides and between adjacent holes 282. A cross-section profile of the grooves 284 may be, for example, v-shaped or chevron shaped. However, other cross-section profiles that allow the grooves 284 to compress with expansion of the HSP 280 under thermal stress may be suitable. The grooves 284 may allow the HSP 280 to expand and may reduce thermal deformation of the HSP 280. In doing so, the grooves 284 may accommodate elongation of the HSP 280 in the horizontal direction with respect to the orientation shown in FIG. 3B and keep stress resulting from the high working temperature experienced during combustion under the yielding stress level for the high-temperature alloy of the HSP 280. Although shown extending between the long sides 281, the grooves 284 need not extend completely across. Nor do the grooves 284 necessarily need to be straight or perpendicular to the long sides 281 of the HSP 280.

To hold the HSP 280 within the housing 246 and further assist in accommodating thermal expansion, the two short sides 283 of the HSP 280 include angled flanges 286 that contact the inner surface 247 (shown in FIG. 3A) of the housing 246 and hold the HSP 280 in place within the housing 246. The angled flanges 286 engage the HSP 280 within the housing 246 by engaging the inner surface 247 of the housing 246 and are shaped to allow thermal expansion of the HSP. To do so, the flanges 286 may not have sharp (e.g., 90 degree) bends or corners with angled edges, but instead may have more curved, rounded, or gradual bends. The flanges 286 thus may bend or flex to absorb thermal expansion of the HSP 280 without resulting in permanent deformation of the HSP 280.

Although shown on the short sides of the HSP 280, the angled flanges 286 may also be located on the long sides of the HSP 280. Although only two angled flanges 286 are shown, the HSP 280 may include any suitable number of angled flanges 286.

To provide further structural support for the HSP 280 without restricting thermal expansion, at least one of the long sides 281 of the HSP 280 includes at least one tab 288 that extends outside of the inner surface 247 of the housing 246. Thus, as the flanges 286 of the HSP 280 are moved into the inside of the housing 246, the tabs 288 contact an outer surface 245 (shown in FIGS. 3A and 3B) of the housing 246 to prevent the HSP 280 from over insertion into the housing 246. The tabs 288 contacting the surface 245 of the housing 246 also helps to maintain a general flatness of the HSP 280 without affixing the HSP 280 to the housing 246. Thus, the tabs 288 provide structural integrity to the HSP 280 while allowing thermal expansion under elevated operational temperatures.

The holes 282 may each include a lip 290 to direct flow of the heated flue gas from the burners 271 into heat exchanger tubes 262. The lip 290 extends past the partition panel 248 and thus the lip 290 helps shield the heat from the combustion from being communicated to the partition panel 248. As shown, the lips 290 extend from the HSP 280 with convex sidewalls. That is, the cross-section of the lip 290 may be a curved funnel profile with a convex sidewall or what may be described as a hollow truncated curved cone. However, the lips 290 do not necessarily need to include convex sidewalls and may include any other suitable profile, such as straight sidewalls.

The HX assembly 260 and an induced draft blower 250 may be enclosed by the cabinet 210. The induced draft blower 250 may be, for example, a variable-speed blower. The HX assembly 260 includes multiple heat exchanger tubes 262 that may be made of, for example, stainless steel. The HX assembly 260, the burner assembly 242, and the induced draft blower 250 operate to burn the fuel, e.g., natural gas, and move the combusted flue gas through the opening in the partition panel 248, the HX assembly 260, out of the furnace assembly 200 through an exhaust vent 251. The burner assembly 242 is located such that the combustion flames from the burners 271 are aligned with and extend toward the tubes 262 when ignited.

The induced draft blower 250 is located downstream of the burner surface 270 and the heat exchanger assembly 260 and is operable to create a negative pressure within the tubes 262 of the heat exchanger assembly 260. The negative pressure in the heat exchanger tubes 262 pulls the heated flue gas from the burners 271 through the heat exchanger tubes 262 and expels the flue gas out of the furnace 200 through the exhaust vent 251.

The controller 230 controls the induced draft blower 250 to control the amount of flue gas pulled into each tube 262 and also controls the fuel valve 240 to control the amount of fuel received by the burner assembly 242, depending on load conditions of the furnace assembly 200. Additionally, the controller 230 controls the air stream blower 220 to move air over the HX assembly 260, thereby transferring heat from the flue gas to an airstream 291 (shown in FIG. 2B) forced over the HX assembly 260 by the blower 220.

In operation of the furnace assembly 200, fuel from the fuel supply is supplied to the intake manifold 241 and controlled by the fuel valve 240. The fuel is mixed with air in the intake manifold 241 to form a fuel/air mixture that is fed into the housing 246 of the burner assembly 242. The mixture is ignited in the burner assembly 242 to produce a flame at each burner 271. Heat from the combustion is transferred through the HSP 280, through the partition panel 248, and into the HX tubes 262 of the HX assembly 260. The HSP 280 shields heat from the combustion from being communicated to the partition panel 248. Structural features of the HSP 280 allow the HSP to undergo thermal expansion due to the combustion without experiencing permanent deformation, thus allowing the HSP 280 to undergo numerous thermal expansion cycles. The induced draft blower 250, downstream of the burner surface 270, operates to create a negative pressure in the heat exchanger tubes 262, thus pulling the heated flue gas from the burners 271 through the heat exchanger tubes 262. An airstream blower 220 operates to pass an air stream 291 over an exterior of the heat exchanger tubes 262 to transfer heat from the HX tubes 262 to the air stream 291. The heated air stream 291 then flows into the interior of the structure 102 through ducts 114 to heat the interior of the structure 102. The operation of the induced draft blower 250, the fuel valve 240, and the air stream blower 220 are controlled using a controller 230 depending on the heating demand of the structure 102.

While the aspects of the present disclosure may be susceptible to various modifications and alternative forms, specific embodiments have been shown by way of example in the drawings and have been described in detail herein. But it should be understood that the invention is not intended to be limited to the particular forms disclosed. Rather, the invention is to cover all modifications, equivalents, and alternatives falling within the spirit and scope of the invention as defined by the following appended claims. For example, certain embodiments disclosed here envisage usage with a powered fan rather than an inducer fan, or no fan at all. Moreover, the rotating equipment (e.g., motors) and valves disclosed herein are envisaged as being operable at specified speeds or variable speeds through inverter circuitry, for example. Moreover, the internal and external communication of the furnace may be accomplished through wired and or wireless communications, including known communication protocols, Wi-Fi, 802.11(x), Bluetooth, to name just a few.

What is claimed is:

1. A furnace assembly for use with a combustible fuel from a fuel supply, comprising:
an intake manifold connectable to the fuel supply in which the fuel is mixable with air to form a pre-mixed fuel and air mixture;
a partition panel;
a burner assembly mountable to the partition panel and operable to combust the pre-mixed fuel and air mixture to produce a heated flue gas, the burner assembly comprising:
a housing connected in fluid communication with the intake manifold;
burners locatable in the housing, each burner configured to produce a flame for the combustion of the mixture into a flue gas; and
a heat shielding plate located and shaped to reduce heat communicated to the partition panel due to the combustion, the heat shielding plate comprising a high-temperature alloy and comprising:
holes through the plate, each hole aligned with one of the burners; and
a groove extending between the holes and shaped to accommodate thermal expansion of and reduce thermal deformation of the plate; and
a heat exchanger mounted to the partition panel in thermal communication with the burners and comprising tubes positioned to receive the heated flue gas from the burners.

2. The assembly of claim 1, wherein the heat shielding plate comprises a rectangular profile comprising two short sides and two long sides and the groove extends between the two long sides.

3. The assembly of claim 1, wherein the groove comprises a v-shape cross-section profile.

4. The assembly of claim 1, where the holes each comprise a lip comprising a curved funnel cross-section profile.

5. The assembly of claim 1, wherein the heat shielding plate comprises a rectangular profile comprising two short sides and two long sides, wherein each short side or each long side comprises an angled flange sized to engage the housing while allowing for thermal expansion of the heat shielding plate.

6. The assembly of claim 5, wherein each angled flange comprises a rounded cross-section profile.

7. The assembly of claim 1, wherein the heat shielding plate comprises a rectangular profile comprising two short sides and two long sides, wherein at least one of the long sides or at least one of the short sides comprises a tab sized to prevent the heat shielding plate from fitting completely inside the housing.

8. The assembly of claim 1, further comprising an inducer blower downstream of the heat exchanger and in fluid communication with the tubes, the blower operable to create a negative pressure in the heat exchanger and pull the combusted flue gas into the tubes.

9. A burner assembly mountable to a partition panel of a furnace assembly and operable to combust a pre-mixed combustible fuel and air mixture to produce a heated flue gas, the burner assembly comprising:
a housing;
at least two burners, each configured to produce a flame for the combustion of the mixture into a flue gas; and
a heat shielding plate located between the burners and the partition panel and configured to reduce the heat communicated to the partition panel due to the combustion, the heat shielding plate comprising a high-temperature alloy and comprising:
holes through the plate, each hole aligned with one of the burners; and
a groove extending between the holes and shaped to accommodate thermal expansion of and reduce thermal deformation of the plate.

10. The burner assembly of claim 9, wherein the heat shielding plate comprises a rectangular profile comprising two short sides and two long sides and the groove extends between the two long sides.

11. The burner assembly of claim 9, wherein the groove comprises a v-shape cross-section profile.

12. The burner assembly of claim 9, where the holes each comprise a lip comprising a curved funnel cross-section profile.

13. The burner assembly of claim 9, wherein the heat shielding plate comprises a rectangular profile comprising two short sides and two long sides, wherein each short side or each long side comprises an angled flange sized to engage the housing while allowing for thermal expansion of the heat shielding plate.

14. The burner assembly of claim 13, wherein each angled flange comprises a rounded cross-section profile.

15. The burner assembly of claim 9, wherein the heat shielding plate comprises a rectangular profile comprising two short sides and two long sides, wherein at least one of the long sides or at least one of the short sides comprises a tab sized to prevent the heat shielding plate from fitting completely inside the housing.

16. A method of operating a furnace assembly for use with a combustible fuel from a fuel supply to heat an interior of a structure, comprising:
supplying fuel from a fuel supply to an intake manifold;
supplying air to the intake manifold to form a pre-mixed fuel and air mixture;
flowing the pre-mixed fuel and air mixture to a burner assembly;
combusting the pre-mixed fuel and air mixture on burners of the burner assembly to produce a heated flue gas;
reducing an amount of heat from the combustion communicated to a partition panel to which the burner assembly is mounted with a heat shielding plate, the heat shielding plate comprising a high-temperature alloy and comprising holes through the plate, each hole aligned with one of the burners;
compressing a groove in the heat shielding plate between the holes during the combustion to accommodate thermal expansion of and reduce thermal deformation of the plate;
operating a blower downstream of the burner assembly to create a negative pressure in a heat exchanger mounted to the partition panel in thermal communication with the burner and comprising tubes and pull the heated flue gas into the tubes;
passing an air stream over an exterior of the tubes to transfer heat from the heated flue gas in to tubes to the air stream to produce a heated air stream; and
flowing the heated air stream into the interior of the structure.

17. The method of claim 16, wherein the heat shielding plate comprises a rectangular profile comprising two short sides and two long sides and the groove extends between the two long sides.

18. The method of claim 16, wherein the groove comprises a v-shape cross-section profile.

19. The method of claim 16, where the holes each comprise a lip comprising a curved funnel cross-section profile.

20. The method of claim 16, wherein the heat shielding plate comprises a rectangular profile comprising two short sides and two long sides, wherein each of the short sides or each of the long sides comprises an angled flange sized to engage a housing of the burner assembly while allowing for thermal expansion of the heat shielding plate.
